(19) United States
(12) Patent Application Publication
(10) Pub. No.: US 2022/0292462 A1
(43) Pub. Date: Sep. 15, 2022

(54) SYSTEMS AND METHODS FOR CALENDARING APPLICATIONS

(71) Applicant: Avaya Management L.P., Durham, NC (US)

(72) Inventors: Shahana Mogal, Pune (IN); Isha Renavikar, Pune (IN); Ananda H P, Pune (IN)

(21) Appl. No.: 17/201,824

(22) Filed: Mar. 15, 2021

(51) Int. Cl. G06Q 10/10; H04L 12/58

(52) U.S. Cl. CPC G06Q 10/1097; H04L 51/02

(57) ABSTRACT

Systems and methods include receiving, with a processor of a computer system, a request for an out-of-office period from a user of an electronic calendar application; determining, with the processor, based on the request for the out-of-office period, a start time and an end time of the out-of-office period; determining, with the processor, based on the start time and the end time, one or more conflicting events on a calendar associated with the user; generating, with the processor, a set of actions for each conflicting event; receiving, with the processor, a response to the set of actions for each conflicting event; and performing, with the processor, one or more of the actions of the set of actions for each conflicting event based on the response.

### FIELD

The disclosure relates generally to electronic calendaring applications and more particularly to automatically generating user interfaces for efficient communication.

### BACKGROUND

As electronic user devices such as smartphones, tablets, computers, etc., become more commonplace, more and more communication between people occurs electronically. The Internet has enabled real-time spread of information.

Using electronic calendar applications, such as Google Calendar™ and Outlook™, users are benefitted with the ability to schedule events for many people with minimal interactions. Calendar items relating to events are created using calendar applications and invitations to such meetings are often sent using email.

Events such as meetings are increasingly created and scheduled using electronic calendaring applications. Invitations to events are increasingly sent using calendaring applications. Conventional electronic calendaring applications allow users to create calendar entries and to associate the entries with dates and times.

Calendaring applications also allow users to create a scheduled out-of-office status. Out-of-office status is often scheduled as a meeting extending the duration of a time for which a user will be away from the office or unable to reply to emails.

These conventional out-of-office statuses, however, have a common annoyance. Currently, when a user has accepted a meeting invite for a meeting during a certain time period and after accepting the meetings sets his or her status as out-of-office for the same time period, the user must remember to manually cancel the acceptance of the meetings and/or inform the organizers of the meetings of his or her planned absence from the meetings. This happens when a meeting is scheduled before an attendee set his/her out-of-office status, or in case of a recurring meeting.

A user's out-of-office status is often set at a moment's notice and the requirement to manually un-accept meeting invites and/or let meeting organizers know of the user's absence from the meetings is often excessively time consuming and inefficient. Users who find themselves unexpectedly out-of-office may take the time to set his or her status as out-of-office but may not be capable of manually un-accepting meeting invites and/or letting meeting organizers know of the user's absence from the meetings.

In these scenarios, the meeting organizer and other attendees may not know about the absence of a user who is out-of-office till the start of the meeting, as an out-of-office update is not communicated to the meeting organizer.

If the user forgets or is unable to update his or her response to the meeting invite, the organizer and other attendees will not know that the particular attendee is not attending the meeting till someone explicitly checks that out-of-office attendee's status.

### BRIEF DESCRIPTION OF THE DRAWINGS

FIG. 1 is a block diagram of a first illustrative system for implementing an electronic calendar application in accordance with one or more embodiments of the present disclosure;

FIG. 2A is a block diagram of a user device system for executing an electronic calendar application in accordance with one or more embodiments of the present disclosure;

FIG. 2B is a block diagram of a server for executing an electronic calendar application in accordance with one or more embodiments of the present disclosure;

FIGS. 3A-3G are illustrations of user interfaces in accordance with one or more embodiments of the present disclosure;

FIG. 4 is a flowchart of a method in accordance with one or more embodiments of the present disclosure.

### DETAILED DESCRIPTION

The above-discussed issues with contemporary calendar applications and other needs are addressed by the various embodiments and configurations of the present disclosure. As described herein, a calendaring application may enable users to implement conflict management by providing options to meeting attendees to update already accepted and/or organized meetings while scheduling out-of-office periods.

Systems and methods as described herein resolve the above-discussed issues by providing an option to users to decline and/or adjust event invitations already accepted and/or organized prior to or in conjunction with setting an out-of-office status for the user. For example, when a user accepts one or more event invitations and later decides to go on a vacation, the user is left with a calendar full of accepted invitations to meetings and events which the user no longer plans on attending. In such a case, using systems and methods as described herein, when the user is setting his or her out-of-office status, the user will be provided with a list of the events that occur during the out-of-office time period and which have already been accepted by the user. The user may then be enabled to select which event invitations to decline and which event invitations to attend in spite of the scheduled out-of-office period. In this way, the user may choose to attend certain events despite being otherwise unavailable. The event organizers may then be enabled to be updated as to the user's out-of-office status and will be made aware of the expected absence of the user for the meeting due to the scheduled out-of-office period.

While the embodiments described herein relate to scheduling an out-of-office request, it should be appreciated the same systems and methods may be used to respond to a user scheduling any type of event which conflicts with one or more other events. For example, instead of scheduling an out-of-office time period, a user may create a new event or accept an invitation to an event which overlaps temporally with one or more existing events on the user's calendar. It should be appreciated that in such a scenario the methods and systems described herein may be used to enable a computer system to automatically act regarding any existing calendar event upon a user scheduling a new event or accepting an invitation to an event which conflicts with any one or more existing events on the user's calendar.

As described herein a user's input may be taken into consideration such that the user can specify which pre-scheduled meetings he or she accepts and which he or she declines when setting his or her out-of-office time period. While setting the out-of-office status, in some embodiments a popup may provide the user a way of selecting meetings to reconfirm acceptance, to decline, to reschedule or to perform other actions regarding any scheduled events or meetings on the user's calendar. Such a system as described herein provides a rich experience to users of an electronic calendar application.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Any combination of one or more computer readable mediums may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

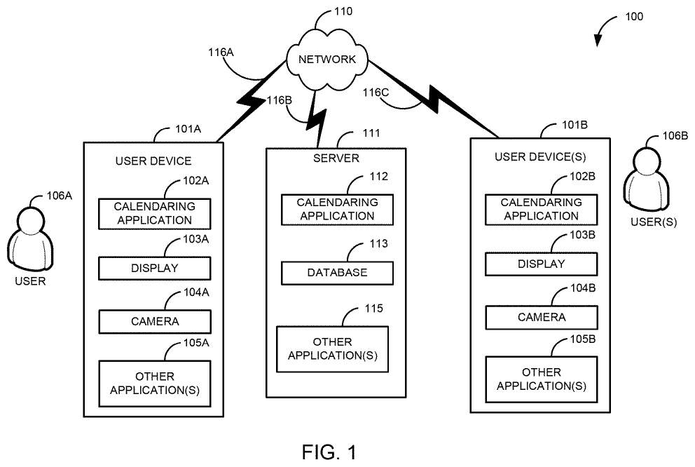

FIG. 1 is a block diagram of a first illustrative system 100 capable of creating electronic calendar items associated with events with calendaring applications, sending electronic invitations, and receiving responses to electronic invitations to organize the flow of data relating to events between one or more users in accordance with one or more of the embodiments described herein. A first illustrative system 100 comprises user communication devices 101A, 101B and a network 110. In addition, users 106A-106B are also shown.

The user communication devices 101A, 101B can be or may include any user device that can communicate on the network 110, such as a Personal Computer (“PC”), a video phone, a video conferencing system, a cellular telephone, a Personal Digital Assistant (“PDA”), a tablet device, a notebook device, a smartphone, and/or the like. Although only two user communication devices 101A, 101B are shown for convenience in FIG. 1, any number of user communication devices 101 may be connected to the network 110 for establishing an event such as a web-conference, video communication, or text-based communications.

The user communication devices 101A, 101B further comprise electronic calendaring applications 102A, 102B, displays 103A, 103B, and cameras 104A, 104B. It should be appreciated that, in some embodiments, user devices may lack cameras 104A, 104B. Also, while not shown for convenience, the user communication devices 101A, 101B typically comprise other elements, such as a microprocessor, a microphone, a browser, other applications, and/or the like.

In addition, the user communication devices 101A, 101B may also comprise other application(s) 105A, 105B. The other application(s) 105A can be any application, such as, a slide presentation application, a document editor application, a document display application, a graphical editing application, a calculator, an email application, a spreadsheet, a multimedia application, a gaming application, and/or the like. The communication applications 102A, 102B can be or may include any hardware/software that can execute an electronic calendar application that is displayed to users 106A or 106B. For example, the communication applications 102A, 102B can be used to execute and display an electronic calendar application.

The displays 103A, 103B can be or may include any hardware display or projection system that can display an image of a video conference, such as a LED display, a plasma display, a projector, a liquid crystal display, a cathode ray tube, and/or the like. The displays 103A-103B can be used to display user interfaces as part of communication applications 102A-102B.

The user communication devices 101A, 101B may also comprise one or more other applications 105A, 105B. The other applications 105A, 105B may work with the electronic calendar applications 102A, 102B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), H.323, video protocol, video protocols, Integrated Services Digital Network (ISDN), and the like. Thus, the network 110 is an electronic communication network configured to carry messages via packets and/or circuit switched communications.

The network may be used by the user devices 101A, 101B, and a server 111 to carry out communication such as interactions using the electronic calendar applications. Data 116A may be sent and/or received via user device 101A, data 116B may be sent and/or received via server 111, and data 116C may be sent and/or received via user device 101B.

The server 111 may comprise any type of computer device that can communicate on the network 110, such as a server, a Personal Computer (“PC”), a video phone, a video conferencing system, a cellular telephone, a Personal Digital Assistant (“PDA”), a tablet device, a notebook device, a smartphone, and/or the like. Although only one server 111 is shown for convenience in FIG. 1, any number of servers 111 may be connected to the network 110 for managing electronic calendar application items.

The server 111 may further comprise an electronic calendar application 112, database(s) 113, other application(s) 115, and, while not shown for convenience, other elements such as a microprocessor, a microphone, a browser application, and/or the like. In some embodiments, machine learning and/or natural language processing algorithms may be executed by the server or other devices to carry out the work of processing event data such as transcribing audio from a live event, while in other embodiments, the server or another device may access one or more third party services provided by, for example, one or more cloud service providers for machine learning and/or audio processing for processing data. In some embodiments, a combination of server-executed artificial intelligence systems and third party-based systems may be used.

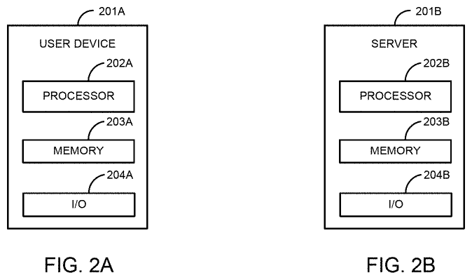

FIGS. 2A and 2B illustrate components of an exemplary user device 201A and server 201B for use in certain embodiments as described herein. In some embodiments, a user device 201A may comprise a processor 202A, memory 203A, and input/output devices 204A. Similarly, a server 201B may comprise a processor 202B, memory 203B, and input/output devices 204B.

A processor 202A, 202B may comprise one or more processors and/or microprocessors. As used herein, processor may refer to a plurality of processors and/or microprocessors operating together. Processors 202A, 202B may be capable of executing software and performing steps of methods as described herein. For example, a processor 202A, 202B may be configured to display user interfaces on a display of a computer device. Memory 203A, 203B of a user device 201A, 201B may comprise memory, data storage, or other non-transitory storage device configured with instructions for the operation of the processor 202A, 202B to perform steps described herein. Accordingly, processes may be embodied as machine-readable and machine-executable code for execution by a processor to perform the steps herein and, optionally, other processing tasks. Input/output devices 204A, 204B may comprise, but should not be considered as limited to, keyboards, mice, microphones, cameras, display devices, network cards, etc.

Illustratively, the user communication devices 101A, 101B, the calendar applications, the displays, the application(s), are stored-program-controlled entities, such as a computer or microprocessor, which performs the methods and the processes described herein by executing program instructions stored in a computer-readable storage medium, such as a memory (i.e., a computer memory, a hard disk, and/or the like). Although the methods described herein may be shown in a specific order, one of skill in the art would recognize that the steps of systems and methods described herein may be implemented in different orders and/or be implemented in a multi-threaded environment. Moreover, various steps may be omitted or added based on implementation.

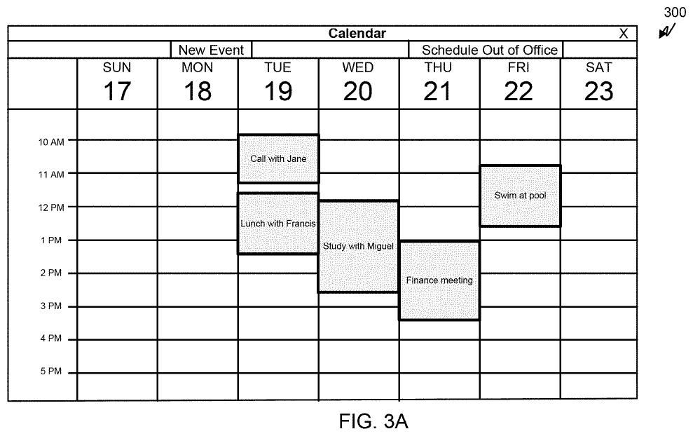

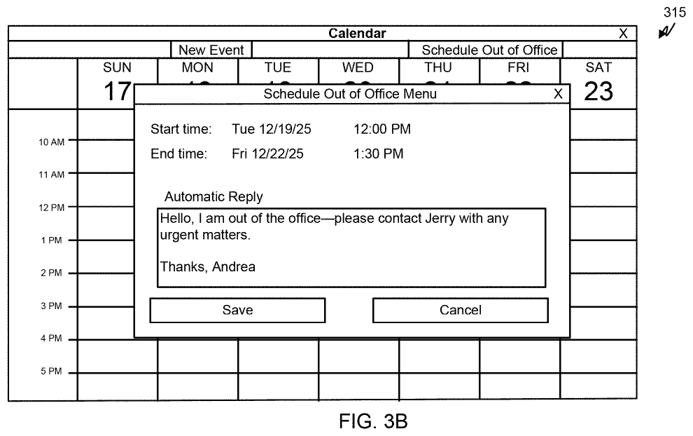

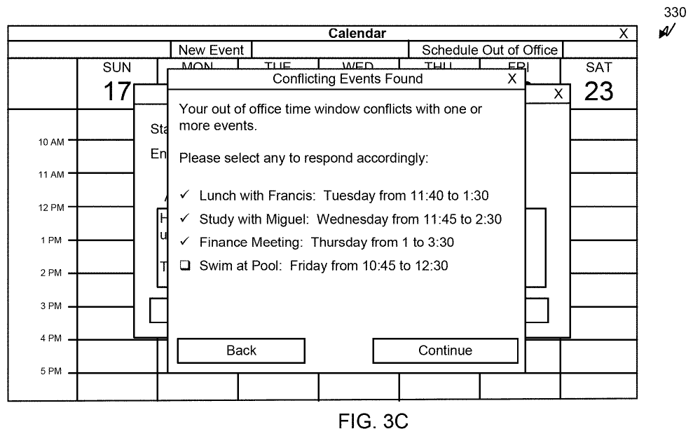

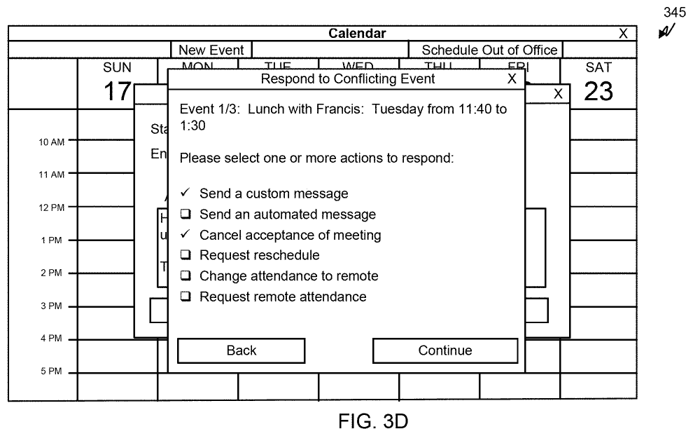

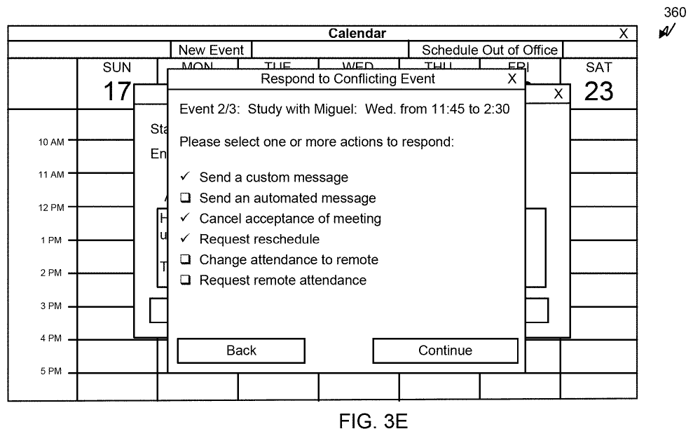

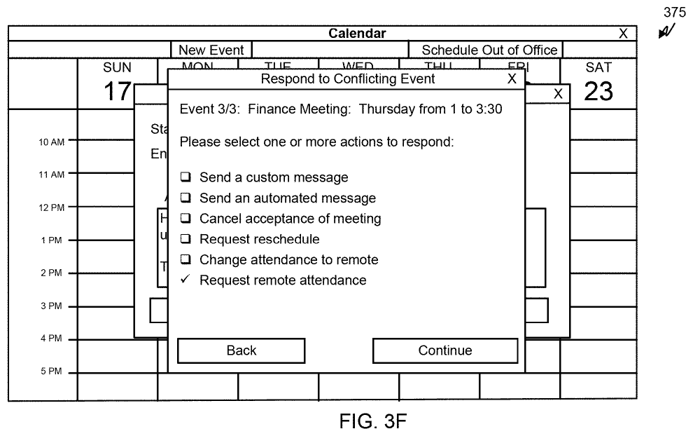

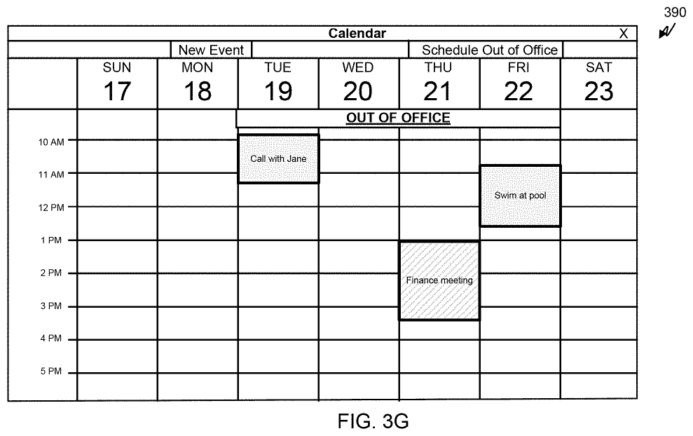

FIG. 3A is an illustration of a user interface 300 for an electronic calendaring application as described herein. The user interface 300 may comprise a view of a calendar. A user interface 300 for an electronic calendaring application may include a daily, weekly, monthly, yearly, or other time-range view. The user interface 300 includes graphical user interface (“GUI”) elements enabling a user to create new calendar items or events and to schedule out-of-office periods. The user interface 300 may also include visual indicators of the events or meetings scheduled during the displayed time range. In the example user interface 300 displayed in FIG. 3, the user has an event “Call with Jane” scheduled on Tuesday, the 19^{th}, from around 10 AM to around 11:15 AM; a “Lunch with Francis” event scheduled on Tuesday, the 19^{th}, from around 11:45 AM to around 1:30 PM; a “Study with Miguel” event scheduled on Wednesday, the 20^{th}, from around 11:45 AM to around 2:30 PM; a “Finance meeting” event scheduled on Thursday, the 21^{st}, from around 1 PM to around 3:30 PM; and a “Swim at pool” event scheduled on Friday, the 22^{nd}, from around 10:45 AM to around 12:30 PM.

Using an electronic calendar application as described herein, a user may be enabled to initiate an out-of-office time period. In some embodiments, a user may initiation as out-of-office time period by interacting with GUI elements in a user interface such as that illustrated in FIG. 3A. Initiating an out-of-office time period may comprise interacting with a GUI element to instruct an electronic calendar application to present an out-of-office scheduling menu such as illustrated in FIG. 3B.

As illustrated in FIG. 3B, an out-of-office scheduling menu may comprise a user interface 315. The user interface 315 of the out-of-office scheduling menu may comprise user-interactable GUI elements such as a text-box or drop-down menu enabling a user to select a start time and date and an end time and date for the user's out-of-office period. The user interface 315 of the out-of-office scheduling menu may also comprise a user-interactable GUI element such as a text-box or drop-down menu enabling a user to input or select a message for the user's out-of-office period. The user's message may be sent in the form of an email as a reply to any emails received during the selected out-of-office time period. A user may be capable of editing existing out-of-office time periods and/or creating new out-of-office time periods.

In the example illustrated in FIG. 3B, a user has selected to be out of the office starting Tuesday, the 19^{th}, at noon, until Friday, the 22^{nd}, at 1:30 PM. The user has input the following text as an automatic reply for the out-of-office time period:
Hello, I am out of the office—please contact Jerry with any urgent matters.
Thanks, Andrea

After inputting a start time and an end time for a scheduled out-of-office time period, the user may be presented with a dialog, such as illustrated in FIG. 3C, in the form of a user interface 330 showing any events currently on the user's calendar which conflict with the scheduled out-of-office time period. Conflicting events may be any events which begin or end during the scheduled out-of-office time period or any events which otherwise overlap temporally with the scheduled out-of-office time period. In some embodiments, any events which end within a predetermined time range of the beginning of the scheduled out-of-office time period or begin within a predetermined time range of the end of the scheduled out-of-office time period may also be considered as conflicting events. For example, if a user is planning on being out-of-office starting at noon, the user may be notified of any event ending at 11:45 AM on the user's calendar. Predetermined time ranges may be custom set by a user using configurations settings or may be set on a system-wide basis.

The user interface 330 showing conflicting events may comprise a list of any events scheduled within or near the scheduled out-of-office time period. A user may be enabled to interact with the list to select for which event or events an action should be performed.

In the example illustrated in FIG. 3C, the user, who has chosen an out-of-office time period of Tuesday, the 19^{th}, at noon, until Friday, the 22^{nd}, at 1:30 PM, and who has the following events on his or her calendar: an event “Call with Jane” scheduled on Tuesday, the 19^{th}, from around 10 AM to around 11:15 AM; a “Lunch with Francis” event scheduled on Tuesday, the 19^{th}, from around 11:40 AM to around 1:30 PM; a “Study with Miguel” event scheduled on Wednesday, the 20^{th}, from around 11:45 AM to around 2:30 PM; a “Finance meeting” event scheduled on Thursday, the 21^{st}, from around 1 PM to around 3:30 PM; and a “Swim at pool” event scheduled on Friday, the 22^{nd}, from around 10:45 AM to around 12:30 PM; is shown a list including: Lunch with Francis: Tuesday from 11:40 to 1:30; Study with Miguel: Wednesday from 11:45 to 2:30; Finance Meeting: Thursday from 1 to 3:30; and Swim at Pool: Friday from 10:45 to 12:30.

As should be appreciated, the list presented in the user interface 330 of FIG. 3C includes those events on the user's calendar which conflict with the schedule out-of-office time period of Tuesday, the 19^{th}, at noon, until Friday, the 22^{nd}, at 1:30 PM.

Using a conflicting events user interface such as illustrated in FIG. 3C, a user may be enabled to select one or more of the conflicting events. In the example of FIG. 3C, the user has selecting three events.

After selecting one or more of the conflicting events, the user may be presented with further dialogs enabling the user to select between one or more options. As illustrated by the user interfaces 345, 360, and 375 of FIGS. 3D, 3E, and 3F, respectively, the user may be enabled to, for each selected conflicting event, choose between sending a custom or automated message to the event organizer, canceling the user's acceptance of the event or meeting, sending a request to the organizer to reschedule the event, changing the user's attendance status from in-person to remote, and sending a request to the organizer that the user be allowed to attend the event remotely.

It should be appreciated that the options available to the user may change depending on factors associated with each event. For example, if remote attendance is not allowed for an event, the user may not be presented with an option to change his or her attendance status to remote, and if remote is allowed for the event, the user may not be presented with an option to request being allowed to attend remotely. Also, while the user interfaces 345, 360, and 375 of FIGS. 3D, 3E, and 3F, respectively, show the user selecting options for each selected conflicting event separately, it should be appreciated that the user may be enabled to select options for multiple events simultaneously in a batch.

Selecting from the options in the user interfaces 345, 360, and 375 of FIGS. 3D, 3E, and 3F, respectively, may present additional dialogs. For example, requesting a custom message be sent to an event organizer may initiate the display of a dialog in which the user may type a custom message, such as “sorry I cannot make it to the meeting,” or select between a number of suggested messages.

In the example user interface 345 of FIG. 3D, the user has selected to cancel his or her acceptance of the “Lunch with Francis” event and send a custom message to the organizer of the event. Following the user inputting the selected options, the event organizer may receive a notification that the user has cancelled acceptance. The notification may also include a custom message input by the user.

In the example user interface 360 of FIG. 3E, the user has selected to cancel his or her acceptance of the “Study with Miguel” event, send a custom message to the organizer of the event, and request the event be rescheduled. Following the user inputting the selected options, the event organizer may receive a notification that the user has cancelled acceptance. The notification may also include a custom message input by the user. The notification, or a separate notification, may inform the event organizer that the user has requested the event be rescheduled.

In the example user interface 375 of FIG. 3F, the user has selected to request he or she be allowed to attend the “Finance Meeting” event remotely. Following the user inputting the selected option, the event organizer for the “Finance Meeting” may receive a notification that the user has requested to attend remotely. The organizer may be enabled to interact with the notification and to choose whether or not to allow the user to attend the event remotely. If the organizer chooses to allow the user to attend the event remotely, the user may then be presented with a notification of the updated allowance. The user's calendar may also be updated to reflect the user's attendance as remote.

After selecting a response for each of the selected conflicting events, the user's calendar user interface may be updated to show the scheduled out-of-office time period as illustrated by the user interface 390 of FIG. 3G. Any events which were cancelled during the scheduling of the out-of-office time period, as discussed herein, may be removed from the calendar or may be grayed-out, or otherwise altered to reflect the cancellation. Any events which were changed to remote attendance may similarly be updated visually. As illustrated in the drawings, the calendar user interface 300 of FIG. 3A has been updated to the user interface 390 of FIG. 3G in which an “OUT OF OFFICE” banner is displayed on the days in which the out-of-office time period is scheduled, the “Lunch with Francis” and “Study with Miguel” events have been removed to reflect the user's cancellation of his or her acceptance, and the “Finance meeting” event has been grayed-out to reflect the user's request for remote attendance. The conflicting “Swim at pool” event is unchanged as the user did not select to perform any action regarding the “Swim at pool” event.

As described herein, an electronic calendar item may be associated with a physical event such as a meeting. A physical event may be a live group of people or may be a virtual event such as a telephone call, video conference, etc. A physical event may last a particular amount of time, such as five minutes or two weeks. It should be appreciated the systems and methods described herein may be used to organize any type of event.

An electronic calendar item may comprise one or more data packets stored in memory of one or more computing systems. An electronic calendar item may comprise data including, but not limited to, a beginning date and time of an event associated with the electronic calendar item, a title of the event, an ending date and time of the event, an identity of an organizer of the event, a list of invitees for the event, etc.

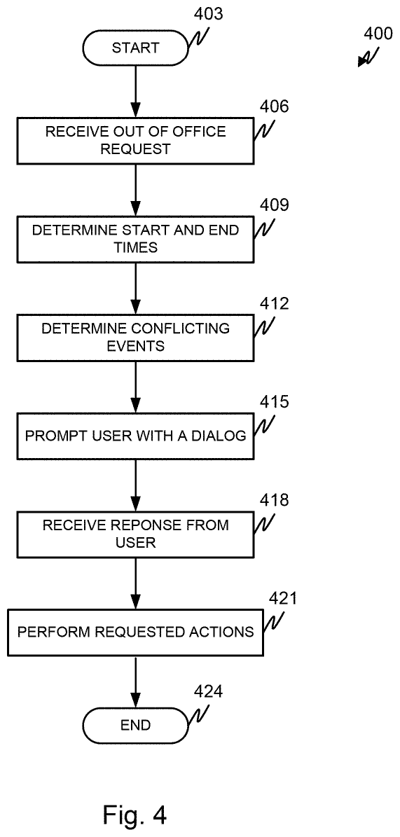

FIG. 4 is a flowchart of a method 400 in accordance with one or more embodiments of the present disclosure. The method 400 may begin at step 403 in which a user of a computer system executing an electronic calendar application may interact with the computer system to request an out-of-office time period be created using the calendaring application. As discussed above, while the embodiments described herein relate to scheduling an out-of-office request, it should be appreciated the same systems and methods may be used to respond to a user scheduling any type of event which conflicts with one or more other events. For example, instead of scheduling an out-of-office time period, a user may create a new event or accept an invitation to an event which overlaps temporally with one or more existing events on the user's calendar. It should be appreciated that in such a scenario the methods and systems described herein may be used to enable a computer system to automatically act regarding any existing calendar event upon a user scheduling a new event or accepting an invitation to an event which conflicts with any one or more existing events on the user's calendar.

At 406, the computer system may receive an out-of-office request or a request for a new event to be added to an electronic calendar from the user. An out-of-office request may be generated upon command by the user interacting with one or more GUI elements within an electronic calendar application. For example, the use may click a “schedule out-of-office” GUI element. An out-of-office request may comprise information input by the user, such as a start date, a start time, an end date, an end time, a custom auto-reply message, and/or other information. The out-of-office request may comprise a data packet containing the information input by the user and/or other information relating to the request for the out-of-office time period. A request for a new event to be added to the user's calendar may be in the form of a new event being created by the user or the user accepting an invitation to an event sent by another user.

At 409, the computer system may determine a start time and date and an end time and date for the out-of-office request. Determining the start time and date and the end time and date for the out-of-office request may comprise receiving the start time and date and the end time and date from the requesting user and may comprise requesting the start time and date and the end time and date from the requesting user. For example, the computer system may generate a request notification which may be presented to the user. The user may respond by inputting the requested start time and date and the end time and date. The computer system may then receive the start time and date and the end time and date as input by the requesting user.

At 412, the computer system may determine one or more conflicting events associated with the out-of-office request. Determining conflicting events associated with an out-of-office request may comprise comparing the start time and date and the end time and date with a calendar associated with the requesting user. For example, the computer system may analyze the calendar to determine any events temporally overlapping the requested out-of-office time period. In some embodiments, a buffer time may be added before and/or after the out-of-office time period. For example, a user may request an out-of-office status for between 2:00 PM and 4:00 PM. The computer system may find any event taking place at least partially between 1:30 PM and 4:30 PM for a buffer time of thirty minutes. It should be appreciated that the buffer time may be user-configurable.

Determining one or more conflicting events may also comprise building a list of the events found to be conflicting. At 415, the computer system may generate a dialog and prompt the user with the dialog. The dialog may in some embodiments comprise a list of the events found to be conflicting with the requested out-of-office time period. The list of events may comprise an indication of the start and/or end times associated with each event. The list of events may also comprise additional information, such as event details stored in the calendar application for each event, an indication of an organizer for each event, an indication of other invitees for each event, etc.

In some embodiments, the computer system may be enabled to determine a priority for each conflicting event and/or the event or out-of-office status being scheduled. In some embodiments, an out-of-office status may be given a highest priority, a meeting created by the user him or herself may be given a second highest priority, a meeting where the user is a mandatory participant may be given a third highest priority, and a meeting where the user is an optional participant may be given a fourth highest priority. Such priorities may be customizable and may be set by each individual user. For example, a user may adjust settings to set events or meetings organized by the user as the highest priority, meetings where the user is mandatory as second highest priority, and out-of-office as third highest priority. Users may also set any event or recurring event as a particular priority individually. It should be appreciated that any event may be of any level of priority based either on user settings, system-wide settings, or characteristics of each event.

The user may be informed of the priority for each conflicting event and/or the event or out-of-office status being added to the user's calendar. In this way, the user may be better informed regarding the proper response for acting on each conflicting event. In some embodiments, actions may be suggested or automatically made based on priority levels of each event. For example, if a conflicting event has a high level of priority, the user may be presented with a suggestion that the event either be rescheduled or a custom message be sent to the organizer. Similarly, if a conflicting event has a low level of priority, the system may suggest the user cancel the event or change his or her acceptance to a declination of the invitation to the event.

The dialog may also include a GUI element enabling the user to input and/or select a message to include as an auto-reply during the out-of-office time period. The auto-reply message may be sent automatically in response to any emails received by the requesting user during his or her out-of-office time period.

The list of conflicting events may be user-interactable such that the requesting user may select one or more of the conflicting events to request an action be performed. When a conflicting event is selected, the computer system may update the dialog or present a second dialog enabling the user to select which action should be performed. For example, a user interface such as illustrated in FIGS. 3D-3F may be generated and presented to the requesting user.

The requesting user may select from between a number of options associated with actions which may be performed. For example, the requesting user may select that a custom or automated message be sent to the organizer of the selected event, that the user's acceptance of an invitation for the selected event be canceled or changed to a declination, that a message be sent to the organizer of the selected event that the event be rescheduled, that the user's attendance status for the selected event be changed to remote, and/or that the organizer be requested to enable remote attendance for the selected event. Such a dialog may be presented for each of the selected events. In some embodiments, a requesting user may be enabled to select actions for multiple conflicting events simultaneously.

In some embodiments, the computer system may be configured to determine whether the requesting user is an organizer of any of the conflicting events. If the requesting user is determined to be an organizer of any of the conflicting events, the requesting user may be presented with a dialog presenting options such as reschedule the event, send a custom or automated message to invitees of the event, change the event type to remote, or other options which may be useful to an organizer of an event who finds him or herself unable to attend the event.

At 418 the computer system may wait for and receive a response from the user. The response from the user may comprise a selection of events for which an action should be performed, a selection of one or more selected actions for each of the selected events, any custom or selected messages which should be sent as part of the actions to be performed for each selected event, and/or other information.

At 421, the computer system may perform the actions requested by the user. For example, the computer system may send messages to organizers and/or invitees to conflicting events, remove the user's attendance from a conflicting event, change the user's attendance type from in-person to remote, reschedule the event, request the event be rescheduled, etc.

At 424, the method 400 may end. While the method 400 is described herein as being performed by a computer system executing a calendar application, it should be appreciated that any computer system capable of receiving information from a user device may be used. For example, methods and systems described herein may be performed by a server in communication with a computer system executing a calendar application.

Embodiments of the present disclosure include a method comprising: receiving, with a processor of a computer system, a request for an out-of-office period from a user of an electronic calendar application; determining, with the processor, based on the request for the out-of-office period, a start time and an end time of the out-of-office period; determining, with the processor, based on the start time and the end time, one or more conflicting events on a calendar associated with the user; generating, with the processor, a set of actions for each conflicting event; receiving, with the processor, a response to the set of actions for each conflicting event; and performing, with the processor, one or more of the actions of the set of actions for each conflicting event based on the response.

Aspects of the above method include the method further comprising updating the calendar associated with the user based on the performed actions.

Aspects of the above method include wherein the one or more actions for a first conflicting event comprises changing an acceptance of an invitation for the conflicting event to a declining of the invitation for the conflicting event.

Aspects of the above method include wherein the one or more actions for a first conflicting event comprises requesting remote attendance to the conflicting event.

Aspects of the above method include wherein the one or more actions for a first conflicting event comprises sending an automated message to an organizer to the conflicting event.

Aspects of the above method include wherein the one or more actions for a first conflicting event comprises sending a notification to organizer to the conflicting event suggesting the conflicting event be rescheduled.

Aspects of the above method include wherein determining the one or more conflicting events comprises determining events on the calendar associated with the user overlapping temporally with the out-of-office period.

Embodiments include a computer system comprising: a processor; and a computer-readable storage medium storing computer-readable instructions which, when executed by the processor, cause the processor to execute a method, the method comprising: receiving, with the processor, a request for an out-of-office period from a user of an electronic calendar application; determining, with the processor, based on the request for the out-of-office period, a start time and an end time of the out-of-office period; determining, with the processor, based on the start time and the end time, one or more conflicting events on a calendar associated with the user; generating, with the processor, a set of actions for each conflicting event; receiving, with the processor, a response to the set of actions for each conflicting event; and performing, with the processor, one or more of the actions of the set of actions for each conflicting event based on the response.

Aspects of the above computer system include the method further comprising updating the calendar associated with the user based on the performed actions.

Aspects of the above computer system include wherein the one or more actions for a first conflicting event comprises changing an acceptance of an invitation for the conflicting event to a declining of the invitation for the conflicting event.

Aspects of the above computer system include wherein the one or more actions for a first conflicting event comprises requesting remote attendance to the conflicting event.

Aspects of the above computer system include wherein the one or more actions for a first conflicting event comprises sending an automated message to an organizer to the conflicting event.

Aspects of the above computer system include wherein the one or more actions for a first conflicting event comprises sending a notification to organizer to the conflicting event suggesting the conflicting event be rescheduled.

Aspects of the above computer system include wherein determining the one or more conflicting events comprises determining events on the calendar associated with the user overlapping temporally with the out-of-office period.

Embodiments include a computer program product comprising: a non-transitory computer-readable storage medium having computer-readable program code embodied therewith, the computer-readable program code configured, when executed by a processor of a first user device, to execute a method, the method comprising: receiving, with the processor, a request for an out-of-office period from a user of an electronic calendar application; determining, with the processor, based on the request for the out-of-office period, a start time and an end time of the out-of-office period; determining, with the processor, based on the start time and the end time, one or more conflicting events on a calendar associated with the user; generating, with the processor, a set of actions for each conflicting event; receiving, with the processor, a response to the set of actions for each conflicting event; and performing, with the processor, one or more of the actions of the set of actions for each conflicting event based on the response.

Aspects of the above computer program product include the method further comprising updating the calendar associated with the user based on the performed actions.

Aspects of the above computer program product include wherein the one or more actions for a first conflicting event comprises changing an acceptance of an invitation for the conflicting event to a declining of the invitation for the conflicting event.

Aspects of the above computer program product include wherein the one or more actions for a first conflicting event comprises requesting remote attendance to the conflicting event.

Aspects of the above computer program product include wherein the one or more actions for a first conflicting event comprises sending an automated message to an organizer to the conflicting event.

Aspects of the above computer program product include wherein the one or more actions for a first conflicting event comprises sending a notification to organizer to the conflicting event suggesting the conflicting event be rescheduled.

Aspects of the above computer program product include wherein determining the one or more conflicting events comprises determining events on the calendar associated with the user overlapping temporally with the out-of-office period.

Examples of the processors as described herein may include, but are not limited to, at least one of Qualcomm® Snapdragon® 800, 810, 820, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Rockchip RK3399 processor, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infrared data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method comprising:
receiving, with a processor of a computer system, a request for an out-of-office period or a new event to be added to an electronic calendar from a user of an electronic calendar application;
determining, with the processor, based on the request for the out-of-office period or the new event, a start time and an end time of the out-of-office period or the new event;
determining, with the processor, based on the start time and the end time, one or more conflicting events on a calendar associated with the user;
generating, with the processor, a set of actions for each conflicting event;
receiving, with the processor, a response to the set of actions for each conflicting event; and
performing, with the processor, one or more of the actions of the set of actions for each conflicting event based on the response.

2. The method of claim 1, further comprising updating the calendar associated with the user based on the performed actions.

3. The method of claim 1, wherein the one or more actions for a first conflicting event comprises changing an acceptance of an invitation for the conflicting event to a declining of the invitation for the conflicting event.

4. The method of claim 1, wherein the one or more actions for a first conflicting event comprises requesting remote attendance to the conflicting event.

5. The method of claim 1, wherein the one or more actions for a first conflicting event comprises sending an automated message to an organizer to the conflicting event.

6. The method of claim 1, wherein the one or more actions for a first conflicting event comprises sending a notification to organizer to the conflicting event suggesting the conflicting event be rescheduled.

7. The method of claim 1, wherein determining the one or more conflicting events comprises determining events on the calendar associated with the user overlapping temporally with the out-of-office period or the new event.

8. A computer system comprising:
a processor; and
a computer-readable storage medium storing computer-readable instructions which, when executed by the processor, cause the processor to execute a method, the method comprising:
receiving, with the processor, a request for an out-of-office period or a new event to be added to an electronic calendar from a user of an electronic calendar application;
determining, with the processor, based on the request for the out-of-office period or the new event, a start time and an end time of the out-of-office period or the new event;
determining, with the processor, based on the start time and the end time, one or more conflicting events on a calendar associated with the user;
generating, with the processor, a set of actions for each conflicting event;
receiving, with the processor, a response to the set of actions for each conflicting event; and
performing, with the processor, one or more of the actions of the set of actions for each conflicting event based on the response.

9. The computer system of claim 8, wherein the method further comprises updating the calendar associated with the user based on the performed actions.

10. The computer system of claim 8, wherein the one or more actions for a first conflicting event comprises changing an acceptance of an invitation for the conflicting event to a declining of the invitation for the conflicting event.

11. The computer system of claim 8, wherein the one or more actions for a first conflicting event comprises requesting remote attendance to the conflicting event.

12. The computer system of claim 8, wherein the one or more actions for a first conflicting event comprises sending an automated message to an organizer to the conflicting event.

13. The computer system of claim 8, wherein the one or more actions for a first conflicting event comprises sending a notification to organizer to the conflicting event suggesting the conflicting event be rescheduled.

14. The computer system of claim 8, wherein determining the one or more conflicting events comprises determining events on the calendar associated with the user overlapping temporally with the out-of-office period or the new event.

15. A computer program product comprising:
a non-transitory computer-readable storage medium having computer-readable program code embodied therewith, the computer-readable program code configured, when executed by a processor of a first user device, to execute a method, the method comprising:
receiving, with the processor, a request for an out-of-office period or a new event from a user of an electronic calendar application;
determining, with the processor, based on the request for the out-of-office period or the new event, a start time and an end time of the out-of-office period or the new event;
determining, with the processor, based on the start time and the end time, one or more conflicting events on a calendar associated with the user;
generating, with the processor, a set of actions for each conflicting event;
receiving, with the processor, a response to the set of actions for each conflicting event; and
performing, with the processor, one or more of the actions of the set of actions for each conflicting event based on the response.

16. The computer program product of claim 15, wherein the method further comprises updating the calendar associated with the user based on the performed actions.

17. The computer program product of claim 15, wherein the one or more actions for a first conflicting event comprises changing an acceptance of an invitation for the conflicting event to a declining of the invitation for the conflicting event.

18. The computer program product of claim 15, wherein the one or more actions for a first conflicting event comprises requesting remote attendance to the conflicting event.

19. The computer program product of claim 15, wherein the one or more actions for a first conflicting event comprises sending an automated message to an organizer to the conflicting event.

20. The computer program product of claim 15, wherein the one or more actions for a first conflicting event comprises sending a notification to organizer to the conflicting event suggesting the conflicting event be rescheduled.
